(19) United States
(12) Patent Application Publication
(10) Pub. No.: US 2025/0265909 A1
(43) Pub. Date: Aug. 21, 2025

(54) ARTICLE-WINNING GAME DEVICE

(71) Applicant: SEGA CORPORATION, Tokyo (JP)

(72) Inventors: Riho Takikawa, Tokyo (JP); Mitsuharu Fukazawa, Tokyo (JP); Takaya Goshozono, Tokyo (JP); Yuuki Hanafusa, Tokyo (JP); Shinpei Nomura, Tokyo (JP); Yuichiro Murotsuka, Tokyo (JP)

(73) Assignee: SEGA CORPORATION, Tokyo (JP)

(21) Appl. No.: 19/198,709

(22) Filed: May 5, 2025

Related U.S. Application Data
(63) Continuation of application No. PCT/JP2023/036810, filed on Oct. 10, 2023.

(30) Foreign Application Priority Data
Nov. 8, 2022 (JP) 2022-178605

(51) Int. Cl. G07F 17/32; A63F 9/30

(52) U.S. Cl. CPC G07F 17/3297; A63F 9/30; G07F 17/3209; G07F 17/3211; G07F 17/3227; G07F 17/3232; G07F 17/3253

(57) ABSTRACT

An article-winning game device includes: a game field that includes a placement area and a dropping slot; a crane that includes an arm; an operating panel that receives an operation by a player; sensors that detect passage of at least one of the articles, and a data processor that: drives the crane in response to the operation, determines whether the at least one of the articles passing through the dropping slot is a first article to be acquired, and sets, based on a user instruction, an acquisition range with respect to the first article. Upon determining that the number of passage reactions with respect to the at least one of the articles passing through the dropping slot is within the acquisition range, the data processor determines that the at least one of the articles passing through the dropping slot is the first article.

### BACKGROUND

### Technical Field

The present invention relates to an article winning game in which articles such as prizes are acquired by moving them.

### Description of Related Art

Many game centers have crane game machines (article acquisition game machines) has been installed. Crane game machines have a stage (game field) inside the housing, and special prizes (article) such stuffed toys, sweets, and the like are placed on the stage. Players use a joystick or various buttons to operate the crane (acquisition mechanism). Upon successfully grabbing a prize with the crane and move it to the dropping slot, players can win prizes (see Patent Document 1).

### PATENT LITERATURE

[Patent Literature 1] JP 2021-145937 A

### TECHNOLOGICAL PROBLEM TO BE SOLVED BY INVENTION

In a crane game machine, in order to create a so that the tip of the crane arm can be inserted under prizes, there are times when balls or other gap-filling components are placed on the stage beforehand. On top of the many balls spread out, prizes are placed thereon. In this configuration, the crane sometimes grabs balls instead of prizes and carries and drops them into the dropping slot accidentally. For business purposes, the operator needs to be aware of the payout rate of the crane game machine, so it is desirable for the operator to be able to recognize whether a prize or an article other than a prize falls into the dropping slot. Also, since there are various prizes that are inserted into the crane game machine, it is necessary to be able to flexibly accommodate a variety of prizes.

### SUMMARY

One or more embodiments of the present invention provide a technology for easily detecting whether articles that have fallen into the dropping slot of the crane game machine are prizes or not.

In one aspect of the present invention, an article-winning game device includes: a game field that is disposed in a play space and includes: a placement area where articles are placed; and a dropping slot through which at least one of the articles may pass, a crane that comprises an arm for acquiring at least one of the articles, an operating panel that receives an operation by a player, sensors that are arranged in the dropping slot and detect passage of the at least one of the articles; and a data processor that: drives the crane in response to the operation, determines whether the at least one of the articles passing through the dropping slot is a first article to be acquired, and sets, based on a user instruction, an acquisition range with respect to the first article, where the acquisition range indicates a range of a number of passage reactions, and the number of passage reactions indicates a number of sensors, among the sensors, that react to an article passing through the dropping slot.

Upon determining that the number of passage reactions with respect to the at least one of the articles passing through the dropping slot is within the acquisition range, the data processor determines that the at least one of the articles is the first article.

According to one or more embodiments of the present invention, the article-winning game device will be able to more easily detect the dropping of prizes using a simple configuration.

### BRIEF DESCRIPTION OF DRAWINGS

FIG. 1 is a perspective view of a crane game machine.

FIG. 2 is a functional block diagram of the crane game machine.

FIG. 3 is a schematic diagram showing the placement state of prizes in the placement area.

FIG. 4 is a perspective view of the base.

FIG. 5 is a perspective view of a prize sensor.

FIG. 6 is a front side view of a prize sensor.

FIG. 7 is a schematic diagram for explaining a method for detecting prizes and color balls.

FIG. 8 is a diagram showing a setting screen.

FIG. 9 is a flowchart showing the process when an article passes through the dropping slot.

FIG. 10 is a schematic diagram showing the relationship in size between unnecessary articles and prizes in a modified example.

FIG. 11 is a perspective view of a prize sensor in a modified example.

FIG. 12 is a graph showing the change over time in the number of passage reactions in the modified example.

FIG. 13 is a front side of view of the prize sensor in a modified example.

FIG. 14 is a first top view of the prize placement stand composed of a plurality of panels.

FIG. 15 is a second top view of the prize placement stand composed of a plurality of panels.

### DETAILED DESCRIPTION OF EMBODIMENTS

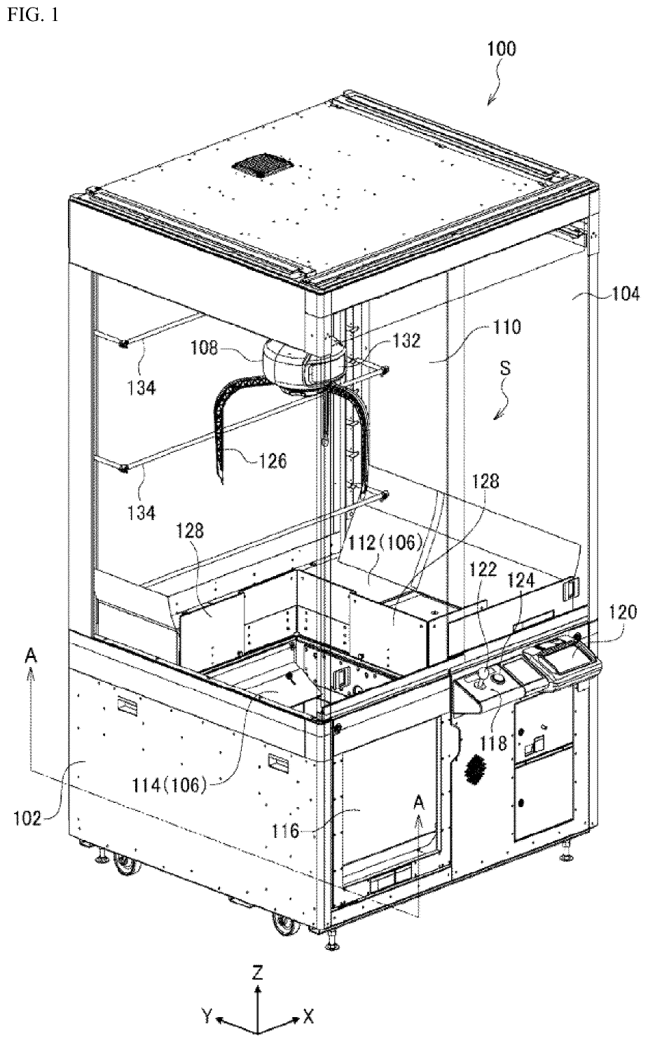

FIG. 1 is a perspective view of crane game machine 100.

The crane game machine 100 is generally installed in amusement facilities, such as amusement parks, game centers, and the like. As shown in FIG. 1, an explanation will be provided the crane game machine 100 as seen by the player with the left and right directions being the X direction, the front and back directions being the Y direction, and the up and down directions being the Z direction.

The crane game machine 100 includes a rectangular parallelepiped base table 102 and a box-shaped prize storage part 104 provided on the rectangular parallelepiped base table 102. A play space S is formed inside the prize storage part 104, and a prize placement table 106 (game field) is disposed in this play space S. In addition to prizes such as stuffed toys, miscellaneous goods, and the like, color balls for decorating the prize placement table 106 are disposed (described below) on the prize placement table 106. A crane 108 is provided above the prize placement table 106. The crane 108 can move back and forth, left and right, and up and down in the play space S to grab/release prizes.

The prize storage part 104 has a front side, a left side, and a right side, which are all made of transparent glass. This was done with consideration given to the visibility of the prizes from outside. A camera may be installed on the ceiling of the prize storage part 104 to photograph the prize placement table 106 from above. A glass door 110 is provided on the front of the prize storage part 104, so that a staff member (store employee) can open the door 110 and place prizes in the prize storage part 104.

The prize placement table 106 is sectioned into a placement area 112 (a first area) and a dropping slot 114 (a second area). The prizes are placed in the placement area 112, and the player can win prizes if they can carry them from the placement area 112 to the dropping slot 114. A shielding plate 128 is installed between the placement area 112 and the dropping slot 114. The shielding plate 128 prevents prizes or color balls in the placement area 112 from falling down into the dropping slot 114.

On the front surface of the base table 102, a prize removal opening 116 is formed for removing prizes dropped from the dropping slot 114.

An operating unit (or operating panel) 118 and a setting display unit 120 are provided on the front side of the base table 102. To start a game, a player inserts a coin into the coin slot or touches an IC card that has been charged with electronic money. Below, with respect to the crane game machine 100, the surface on which the operating unit 18 and the like are installed, in other words, the surface on which the player is located, is called the “front side”, and the surface on the back side (the side in the positive Y-axis direction) as seen from the player is called the “back side”.

The control unit 118 includes a control stick 122 for moving the crane 108 back and forth and left and right to determine the point of descent, and a grab button 124 for lowering the crane 108 to grab prizes.

A touch panel is provided to the setting display unit 120. The setting display unit 120 functions as a “setting input unit” where the operator (store employee) enters game setting information, and functions as a “display unit” that displays information about the game, such as how to operate the operating unit 118, game results, and the like. The crane game machine 10 also includes a speaker (not illustrated), an external connection terminal, and the like.

The crane 108 has three arms 126 capable of grasping and releasing prizes. The number of arms 126 may be two or four or more. The crane 108 includes a motor that drives the arms 126 to open and close. The crane 108 grasps and releases prizes by opening and closing the arms 126.

The crane 108 can move along a guide rail (not illustrated) installed above the prize storage part 104, and is driven by a crane driver 130 (described below). The crane driver 130 includes a moving mechanism that drives the crane 108 in the horizontal (X-direction) and in the vertical direction (Y direction) and a lifting-lowering mechanism that drives the crane 108 in the up-down direction (Z direction). The movement mechanism includes an X-direction motor and a Y-direction motor. The lifting-lowering mechanism includes a Z-direction motor. The crane driver 130 can drive the crane 108 to be able to move to any position in the play space S.

The crane 108 in one or more embodiments is the so-called “triple catcher” type, which has three arms 126. If players complete the game within the time limit, for example, the crane 108 can be freely moved forward, backward, left, and right by the operating stick 122. The player moves the crane 108 above the prize and then presses the grab button 124. When the grab button 124 is pressed, the crane 108 will descend. The crane 108 automatically moves the arms 126 in the closing direction (hereinafter referred to as “grabbing” or “grabbing action”) after descending a predetermined distance. At this time, the crane 108 is able to use the arms 126 to grab the relatively large prizes at the descent point. In addition, when the grip button 124 is pressed again while the crane 108 is descending, the arms 126 can be caused to perform a grabbing action at the time the grip button 124 is pressed.

While maintaining the grabbing action, the crane 108 will rises, and then automatically move to the dropping slot 11. The crane 108 will move the arms 126 in the releasing direction (hereinafter referred to as “releasing” or “releasing action”) above the dropping slot 114. If a prize is firmly grasped, the prize carried by the crane 108 to the dropping slot 114 and then dropped from above the dropping slot 114 (crane game success). On the other hand, if the arms 126 are not able to grasp the prize firmly, the prize may fall from the crane 108 before the crane 108 reaches directly above the dropping slot 114 (crane game failure).

The operator can also rotate the crane 108 horizontally (rotates around the Z axis). As shown in FIG. 1, while the home position is when one of the three arms 126 is on the player's side, the operator can adjust the horizontal rotation angle of the crane 108 in light of the prize arrangement situation. A design cover 132 is installed on the front surface of the crane 108. In one or more embodiments, a logo (advertising information) indicating the product name is printed on the design cover 132.

A plurality of optical sensors are installed inside dropping slot 114. The optical sensors detect prizes falling into the dropping slot 114 (hereinafter, also simply referred to as “prize acquisition”). In addition, while these optical sensors are configured to be able to distinguish whether color balls or prizes have dropped, the details will be described later in relation to FIG. 4, etc.

At the rear of the prize storage part 104, one or more display bars 134 are installed. The display bar 134 is a metal bar extending in the X direction, and prizes for display can be placed inside. The operator opens the door 110 and drops it into the dropping slot 114 to place display bar 134 on the back side. The number and height of the bars 134 may be freely determined.

A storage box for storing color balls and other equipment is provided at the back of the dropping slot 114.

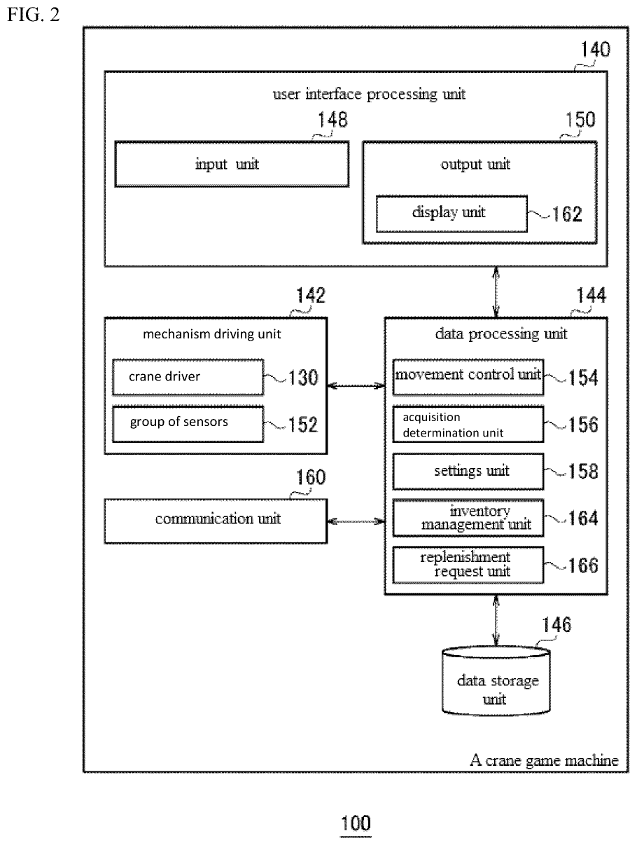

FIG. 2 is a functional block diagram of the crane game machine 100.

Each constituent element of the crane game machine 100 is realized by hardware that includes arithmetic units such as a CPU (Central Processing Unit) and various co-processors, memory and storage devices, and wired or wireless communication lines that connect these together, as well as software that that is stored in the storage device and provides processing instructions to the arithmetic units. A computer program or instructions may be composed of a device driver, an operating system, various application programs that are located in the upper layer of these, and libraries that provide common features to these programs or instructions. Each block described below are composed of functional block units instead of hardware units.

The crane game machine 100 includes a user interface processing unit (or user interface processor) 140, a mechanism driving unit 142, a data processing unit (or data processor) 144, a communication unit 160 (or communication interface), and a data storage unit (or data storage) 146.

The user interface processing unit 140 receives operations from a player via various input devices, and is also responsible for user interface-related processing such as image display and audio output. The mechanism driving unit 142 drives the various acquisition mechanisms such as the crane 108. The data storage unit 146 stores various data. The data processing unit 144 executes various processes based on the input from the user interface processing unit 140 and the data stored in the data storage unit 146. The communication unit 160 is responsible for communication with external devices such as the store terminal used by the operator. The data processing unit 144 also functions as an interface for the mechanism driving unit 142, user interface processing unit 140, communication unit 160, and data storage unit 146.

The user interface processing unit 140 includes an output unit 150 that outputs various information to the input unit 148. The output unit 150 includes a display unit 162 that outputs images. The display unit 162 displays various images on a display device such as the setting display unit 120.

The input unit 148 receives setting input from an operator (user) via the setting display unit 120. The input unit 148 also receives operation input from the player via the operating unit 118. The crane game machine 100 has two setting modes. In the settings mode, the operator can configure various settings (describe below). The settings for delivery of prizes or installation of the display bar 134 are also set while in the settings mode. In the play mode, a player operates the operating unit 118 to play the crane game.

The mechanism driving unit 142 includes the crane driver 130 and a group of sensors 152. As mentioned above, the crane driver 130 is used to move the crane 108 and to grab and release the arms 126. The group of sensors 152 corresponds to the optical sensors (described below) and the like at the dropping slot 114.

The data processing unit 144 includes the movement control unit 154, the acquisition determination unit 156, the settings unit 158, an inventory management unit 164, and a replenishment request unit 166.

The movement control unit 154 instructs the crane 108 to move, grab, and release according to the operation instructions from the operating unit 118. The acquisition determination unit 156 determines whether the prize has fallen into the dropping slot 114, or in other words, whether the crane game has been successful. In addition, the acquisition determination unit 156 also determines whether the article that has passed through the dropping slot 114 is a prize (a first article) or a color ball (a second article) (described below). In the settings mode, the operator can set the size of prizes. The settings unit 158 is used to set the detection criteria for prizes or color balls according to the operator's input (described later). The inventory management unit 164 manages the number of prizes remaining on the prize placement table 106 (hereafter simply referred to as “the remaining number”). When the remaining number falls below the specified threshold T, the replenishment request unit 166 instructs the communication unit 160 to send a request for replenishment of the prizes to the store terminal. The operator can freely set the threshold T in the settings mode.

The data storage unit 146 stores information such as the crane game program, crane game settings, and game play results (payout rate).

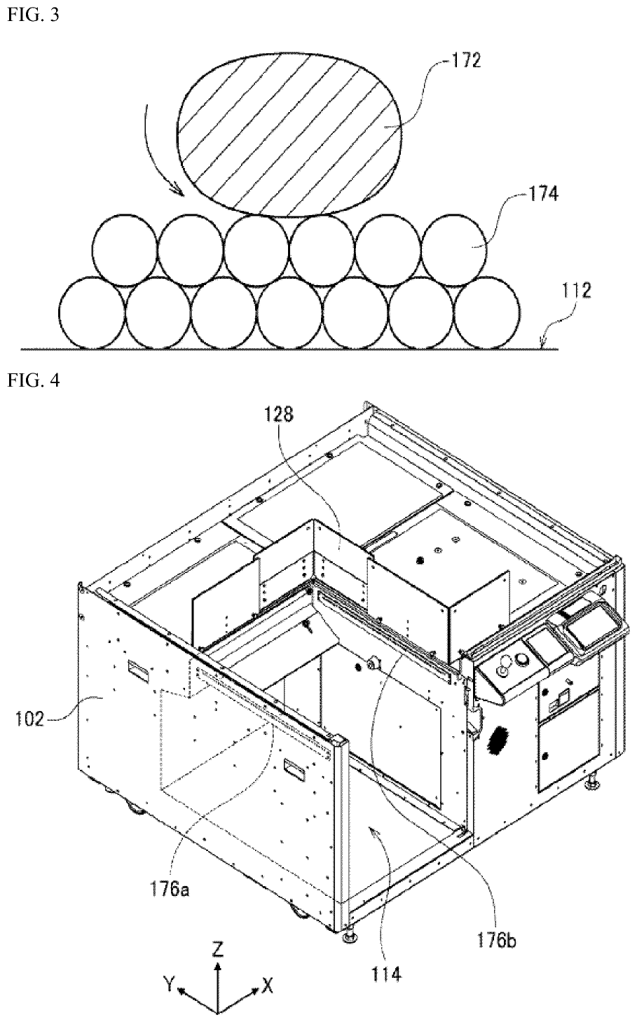

FIG. 3 is a schematic diagram showing the placement state of a prize 172 in the placement area 112.

A plurality of color balls 174 are laid out in the placement area 112. Various prizes 172 such as stuffed toys and the like are placed on a layer of color balls 174. In this case, the dimensions of the prize 172 in length, width, and depth are all larger than those of the color balls 174. The color balls 174 are vinyl balls having elasticity. One of the purposes of laying down the color balls 174 is to enhance the decorative quality of the play space S. In addition, because there is a possibility that the arms 126 or the placement area 112 will become damaged if the arms 126 come into direct contact with the placement area 112, a layer of color balls 174 is formed to prevent contact between the placement area 112 and the arms 126.

In addition, the layers of color balls 174 create a gap underneath the prizes 172, making it easier to insert the arm 126 underneath prize 172s. Therefore, by creating a layer of color balls 174, the arms 126 will be able to firmly grab prizes 172.

The prize that the player can obtain is the prize 172, and the color balls 174 are not originally intended to be acquired as prizes. However, in rare cases, color balls 174 may be picked up by the arms 126 and fall into the dropping slot 114. The operator needs to be aware of the payout rate of the crane game machine, i.e. the difficulty of acquiring prizes. For this reason, crane game machines 100 need to have a feature that detects the fall of prizes 172. There is a possibility that when color balls 174 fall into the dropping slot 114, it will be mistakenly recognized as the acquisition of the prize 172. The following explains the structure for easily distinguishing between color balls 174 or a prize 172 that has fallen into the drop slot 114.

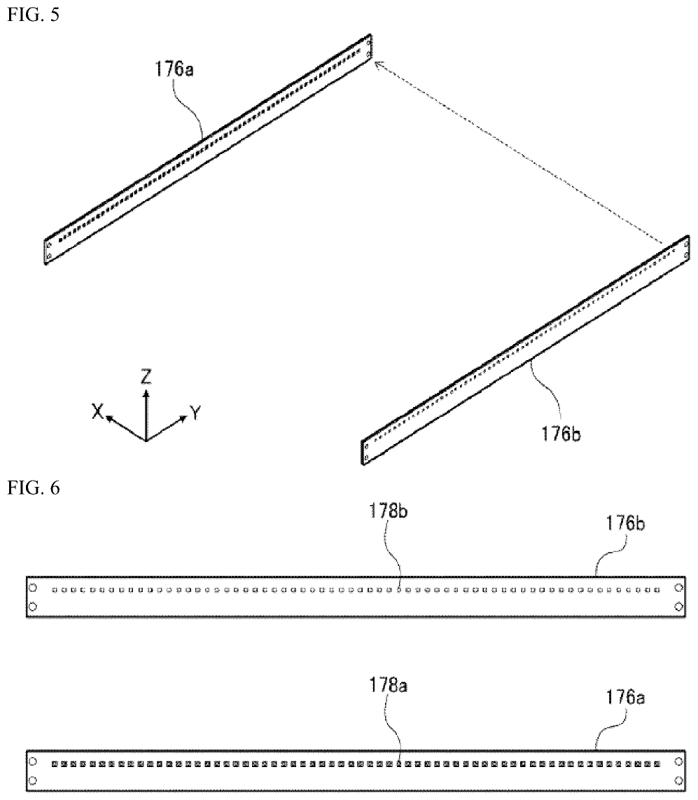

FIG. 4 shows a perspective view of the base table 102. FIG. 5 shows the diagonal of the prize sensor 176.

The prize sensor 176 is disposed on the inner wall surface of the dropping slot 114. The prize sensor 176 includes a first detection plate 176a (a first detection unit) and a second detection plate 176b (a second detection unit) that face each other. There are 50 optical sensors each on the first detection plate 176a and the second detection plate 176b, for a total of 100 optical sensors.

Alternatively, instead of attaching the first detection plate 176a and second detection plate 176b to the inner wall of the dropping slot 114, the optical sensor 178 may be attached directly to the inner wall of the dropping slot 114, causing a portion of the inner wall to function as a “detector”.

On the second detection plate 176b, 50 light-emitting elements 178b (optical sensors 178) are arranged in a single line at 7-mm intervals. On the first detection plate 176a, 50 light-receiving elements 178a (optical sensors 178) are arranged in a single line at 7-mm intervals. That is, the light-receiving elements 178a and the light-emitting elements 178b are a pair or the like, and the light emitted from the nth light-emitting element 178b is received by the nth light-receiving element 178a, which is located opposite to this light-emitting element 178b. From now on, the nth light-receiving element 178a will be written as “light-receiving element 178a(n)”. The same is true for the light-emitting elements 178b.

The 50 light-emitting elements 178b arranged on the second detection plate 176b emit light one by one, from the light-emitting element 178bs (1) at one end of the second detection plate 176b to the light-emitting elements 178b (60) at the other end. Therefore, the 50 light-receiving elements 178a arranged on the first detection plate 176a also receive light in sequence. The method in which light is emitted sequentially from the light-emitting element 178b (1) to the light-emitting element 178b (60), followed by light being received sequentially from light-receiving element 178a (1) to the light-emitting element 178b (60) is called the “scan method”.

When a prize 172 or a color ball 174 passes through the dropping slot 114, because the article will block or shield the light from the light-emitting element 178b, part of the light-receiving element 178a will be unable to detect the light at the timing when it should be receiving the light. The blocking of shielding of light to the light-receiving elements 178a by an article is called a “passage reaction”. The number of light-receiving elements 178a that detect a passage reaction is called the “number of passage reactions”. In one or more embodiments, because the scanning speed is sufficiently high compared to the falling speed of an article, a passage reaction occurs in a plurality of light-receiving elements 178a during the article's passage.

The acquisition determination unit 156 controls the emission of the light-emitting elements 178b by the scanning method. In addition, the acquisition determination unit 156 detects the number of passage reactions from the light-receiving elements 178a, and determines whether an article has passed through the dropping slot 114, and whether the article that has passed through the dropping slot 114 is a prize 172 or a color ball 174 based on the number of passage reactions. As mentioned above, because the optical sensors 178 are arranged at 5-mm intervals, in theory it should be possible to detect the passage of articles with a width of 7 mm or more. However, in one or more embodiments, it is assumed that objects with a width of 30 mm or more will be detected.

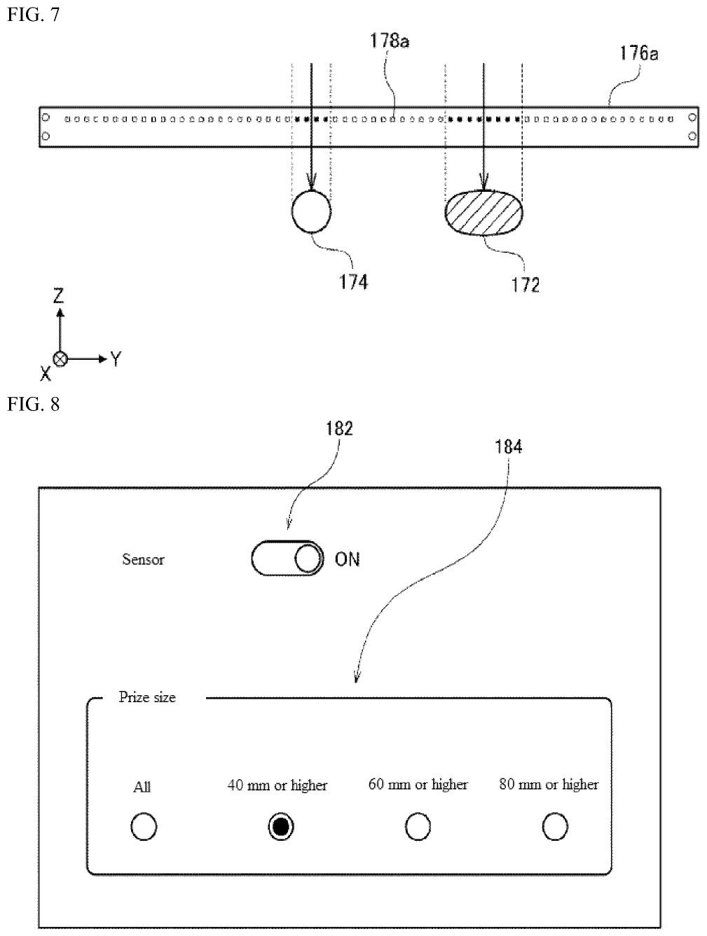

FIG. 7 is a schematic diagram for explaining a method for detecting the prize 172 and the color ball 174.

In one or more embodiments, the diameter of the color balls 174 is assumed to be 30 mm. In addition, the width of the prize 172 is assumed to be at least 80 millimeters.

When an article such as a prize 172 passes through the dropping slot 114, a passage reaction is detected by some of the light-receiving elements 178a. When a passage reaction is detected, the acquisition determination unit 156 recognizes that a prize 172 or a colored ball 174 has passed in front of the optical sensors 178.

Since the diameter of the color balls 174 is 30 mm, it is estimated that the number of passage reactions when the color balls 174 pass through the dropping slot 114 is about 4 to 5. On the other hand, since the width of the prize 172 is more than 80 mm, the number of passage reactions when the prize 172 falls into the dropping slot 114 will be 11 or more. When a passage reaction is detected by any of the optical sensors 178, if the number of passage reactions is 5 or less, the acquisition determination unit 156 determines that the color balls 174 have dropped, and if the number is 11 or more, the acquisition determination unit 156 determines that the prize 172 has dropped.

With this type of control method, it is possible to recognize whether the prize 172 or a color ball 174 has dropped based on the number of passage reactions detected by the plurality of optical sensors 178 by using a simple configuration.

Since the shapes of the prizes 172 are various, the detection criteria based on the number of passage reactions need to be set flexibly depending on the prize. The number of passage reactions also differs depending on the direction in which the prizes 172 fall. In addition to the color balls 174, there are also other articles that are not eligible for collection (hereafter referred to as “unwanted articles”) that are sometimes put into the prize storage part 104. Therefore, the criteria for detecting unwanted articles must be adjusted according to the type of unwanted article.

FIG. 8 is a screen diagram of the settings screen 180.

In the settings mode, the display unit 162 displays a settings screen 180. The settings screen 180 is displayed on the settings display unit 120. The settings screen 180 includes a sensor on button 182 and a size settings area 184. When the sensor ON button 182 is set to ON, the prize sensor 176 becomes enabled. The size settings area 184 is the area for setting the size of the prize 172. The operator sets the size of the prizes 172 to be inserted into the crane game machine 100 in the size settings area 184. The size of the prize 172, or in other words, the width, depends on the orientation of the prize 172. Therefore, it is best to set the size based on the minimum width of the prize 172. In FIG. 8, it is set to “40 mm or more”.

The settings unit 158 sets the range of the number of passage reactions corresponding to the prize 172 (hereinafter referred to as the “acquisition range”) corresponding to “40 mm”. For example, the option “40 mm or more” is pre-assigned to the acquisition range “5 or more passage reactions (7×5=35 mm or more)”. Therefore, when the setting is “40 mm or more” as shown in FIG. 8, the acquisition determination unit 156 determines that the prize 172 has been acquired if the number of passage reactions when an article passes through the dropping slot 114 is five or more. On the other hand, if the number of passage reactions is outside the acquisition range, i.e., if it is four or less, the article that passed through the dropping slot 114 is determined to be an unwanted article such as color balls 174.

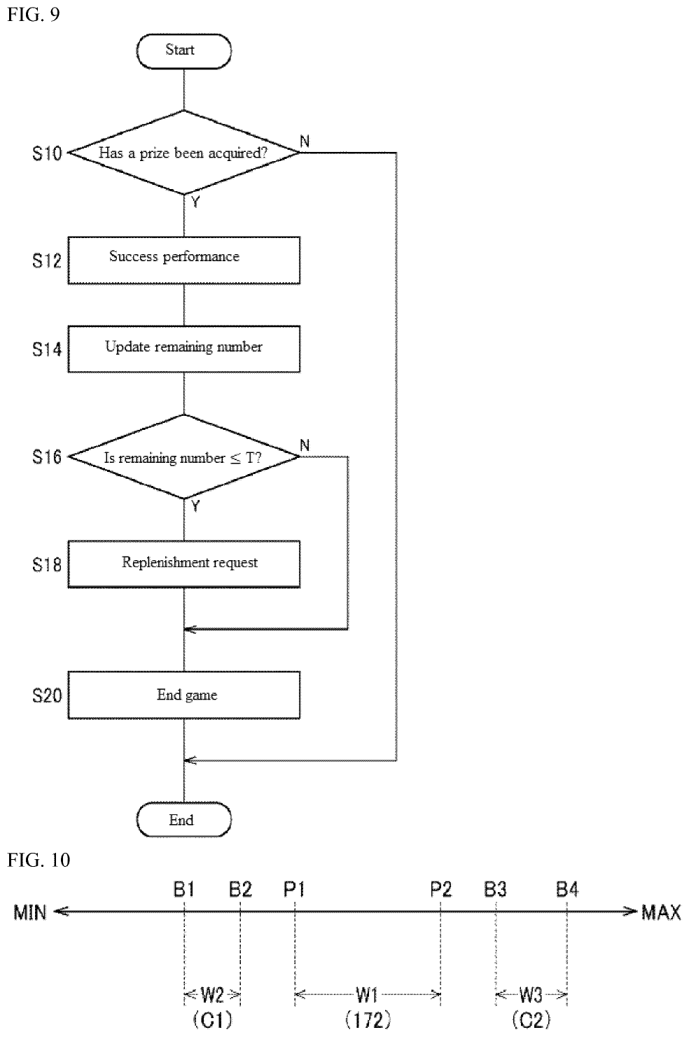

FIG. 9 is a flowchart showing the processing process when an article passes through the dropping slot 114.

When a passage reaction is detected in any of the light-receiving elements 178a on the first detection plate 176a, the processing shown in FIG. 9 is started. If the number of responses is within the acquisition range (Y in S10), the acquisition determination unit 156 determines that a prize has been acquired. If the number of passage reactions is outside the acquisition range (N in S10), the acquisition determination unit 156 determines that color balls 174 have fallen instead of the prize 172.

If a prize is obtained (S10 Y), the acquisition determination unit 156 instructs the output unit 150 to execute a performance corresponding to the prize acquisition (hereinafter referred to as “success performance”) (S12). As a success performance, for example, an image on the display of the settings display unit 120, etc. can be displayed to congratulate the player on winning a prize, or a sound can be output. In addition, the prize acquisition determination unit 156 updates the so-called “payout rate”, that is, the rate of the number of times the prize was successfully acquired relative to the number of attempts at the crane game, whenever a prize is acquired.

The number of prizes 172 in stock is set in advance whenever the operator inserts a prize 172 into the crane game machine 100. The prize acquisition determination unit 156 updates the remaining number of prizes 172 each time a prize acquisition is detected (S14). When the remaining number falls below the threshold T (Y in S16), the replenishment request unit 166 instructs the communication unit 160 to send a replenishment request to the store terminal (S18). The replenishment request includes the ID of the crane game machine 100 and the type of prize 172. When the operator receives a replenishment request, the operator replenishes prizes 172. In other words, whenever the number of prizes 172 remaining decreases due to prize acquisition, a replenishment request is automatically sent to the operator, which prevents the crane game machine 100 from running out of prizes 172. If the remaining number is greater than the threshold T, that is, if there are enough prizes left in the crane game machine 100 (N in S16), the processing in $18 is skipped.

Whenever a prize is successfully acquired (Y in S10), the game will end even if the time limit has not yet been reached (S20). If a prize is not acquired (N in S10), the game will continue until the time limit expires or until success in acquiring a prize has been achieved.

The crane game machine 100 has been described above based on one or more embodiments. In one or more embodiments, the placement area 112 is covered with multicolored color balls 174, and the prizes 172 are placed on the layer of color balls 174. For this reason, it is also possible that the color balls 174, rather than prizes 172, fall into the dropping slot 114. A prize sensor 176 formed on the inner wall of the dropping slot 114 is equipped with a plurality of optical sensors 178. Depending on the number of responses from the optical sensor 178, the acquisition determination unit 156 can determine whether a prize 172 or a color ball 174 has dropped.

The operator sets the size of the prize 172 in the settings screen 180, and the acquisition determination unit 156 sets the acquisition range according to the set size. The operator can flexibly set an appropriate acquisition range to match the wide variety of prizes 172.

Whenever a prize is won, the inventory management unit 164 updates the remaining number of prizes 172. The replenishment request unit 166 sends a replenishment request to the store terminal when the remaining number becomes low. With this kind of control, the operator can replenish the prizes 172 in the crane game machine 100 at the appropriate time so that the number of remaining prizes 172 does not become too low.

The present invention is not limited to the above embodiments or modifications, and the constituent elements can be modified and embodied within a scope that does not deviate from the idea of the invention. Various inventions may be formed by combining the plurality of components disclosed in the abovementioned embodiments and modifications as appropriate. In addition, some of the components shown in the abovementioned embodiments and modifications may be deleted.

### Modifications

In one or more embodiments, the prizes 172 and colored balls 174 are discriminated by the prize sensor 176. As an example of a modification, a plurality of types of prizes 172 of different sizes may be placed in the placement area 112. Depending on the number of responses from the optical sensor 178 in the prize sensor 176, the acquisition determination unit 156 may determine which of the plurality of types of prizes 172 has fallen into the dropping slot 114.

FIG. 10 is a schematic diagram showing the relationship between the size of the unwanted articles and the prizes 172 in the modification.

A plurality of types of unnecessary articles may alternatively be placed on the crane game machine 100. For example, let's assume that unwanted articles C1 and C2, which are different sizes, and a prize 172 are inserted into the crane game machine 100. The horizontal axis in FIG. 10 indicates size, with the right side corresponding to the largest size and the left side corresponding to the smallest.

The width of the unwanted article C1 is greater than B1 and less than B2, and W2=B2−B1 is the size range of the unwanted article C1. The operator may set the size of not only the prizes 172 but also unwanted articles. The settings units 158 sets the range of the number of passage reactions corresponding to the size range W2 of the unwanted article C1 (hereinafter referred to as the “unwanted range”). Unwanted article C2 is larger than unwanted article C1, and its width is B3 or more and B4 or less. The size range W3 for unwanted article C2 is “B3-B4”. The settings unit 158 also sets the unwanted range for the unwanted article C2.

Similarly, the width of the prize 172 is greater than or equal to P1 and less than or equal to P2, and its size range is W1. In FIG. 10, because W1, W2, and W3 do not overlap with each other, the acquisition determination unit 156 can distinguish between prizes 172 and unwanted articles C1 and C2.

More specifically, the acquisition determination unit 156 determines that the unwanted article C1 has fallen if the number of passage reactions is within the unwanted range (C1), and determines that the unwanted article C2 has fallen if the number of passage reactions is within the unwanted range (C2). In addition, if the number of passage reactions is within the acquisition range, the acquisition determination unit 156 determines that the prize 172 has been dropped, that is, that a prize has been successfully acquired.

The operator may have the crane game machine 100 memorize the unwanted range and the acquisition range by actually dropping prizes 172, etc. into the dropping slot 114 rather than by using the settings screen 180. For example, in the settings mode, the operator inputs “Unwanted article C1”. At this time, the display unit 162 will display “Please drop the unwanted article C1 into the dropping slot 114 ten times”. The operator will then drop the unwanted article C1 into the dropping slot 114, and the acquisition determination unit 156 will detect the number of passage reactions at that time. The settings unit 158 may set the unwanted range (C1) as the range of the number of passage reactions whenever the unwanted article C1 is dropped a plurality of numbers of times.

The unwanted range of unwanted items C2 and the acquisition range for prizes 172 can be set in the same way. With this type of control method, the operator can make the crane game machine 100 memorize an appropriate unwanted range and acquisition range simply by dropping various articles into the dropping slot 114, without having to manually enter the size on the settings screen 180.

With the settings unit 158, it is acceptable to set the minimum and maximum numbers of passage reactions whenever an article is dropped as the unwanted range or the acquisition range or to set a range with a specified width centered on the average value of the passage reactions as the unwanted range or the acquisition range.

There are various shapes of the unwanted items and prizes 172 that are fed into the crane game machine 100. As mentioned above, the number of reactions that occur when an article that is not spherical, such as a rectangular prism, falls also changes depending on the angle of fall. If the unwanted range and the acquisition range overlap, or if the boundary values of the unwanted range and the acquisition range are less than a specified number, the output unit 150 may warn the operator that “there is a possibility that the prize cannot be recognized correctly with this combination of items”.

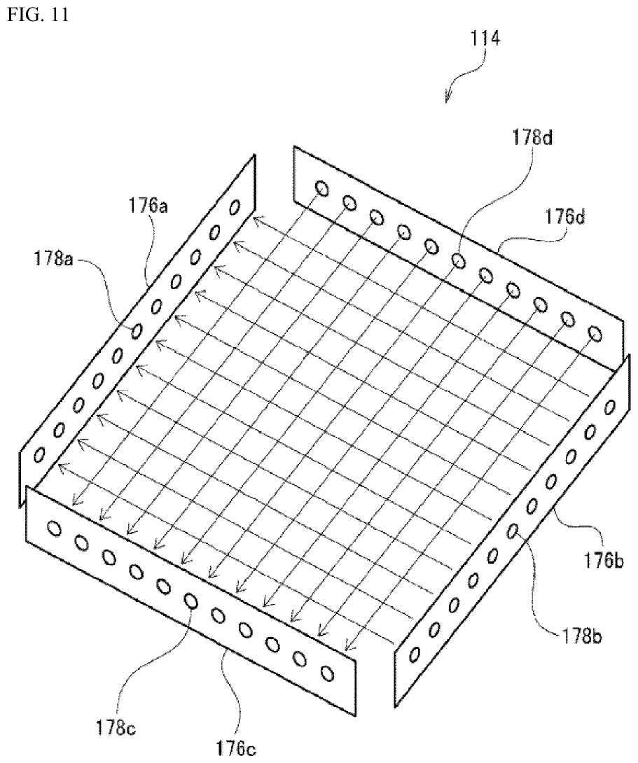

FIG. 11 is a perspective view of the prize sensor 176 in a modified example.

In one or more embodiments, the first detection plate 176a and the second detection plate 176b are opposed, and the articles passing through the dropping slot 114 are detected by the light emitted by the light-emitting element 178b when it is received by the light-receiving element 178a. As a modification, prize sensors 176 may be placed on all four sides of the dropping slot 114.

In the present modification, as shown in FIG. 11, not only is the first detection plate 176a (third side) disposed in a position opposite to the second detection plate 176b (first side), but also the third detection plate 176c (fourth side) is disposed in a position opposite to the fourth detection plate 176d (second side). The fourth detection plate 176d has a plurality of light-emitting elements 178d arranged thereon, and the third detection plate 176c has a plurality of light-receiving elements 178c arranged thereon. When articles pass through the dropping slot 114, a passage reaction is detected by the light-receiving elements 178a arranged on the first detection plate 176a and the light-receiving elements 178c arranged on the third detection plate 176c.

The acquisition determination unit 156 determines whether a prize has been acquired based on whether the total number of passage reactions detected by the light-receiving element 178a (first detection plate 176a) and the light-receiving element 178c (third detection plate 176c) are within the predetermined acquisition range. Alternatively, the acquisition determination unit 156 may alternatively determine that a prize has been acquired when the number of passage reactions of the light-receiving element 178a is within a first acquisition range and the number of passage reactions of the light-receiving element 178c is within a second acquisition range.

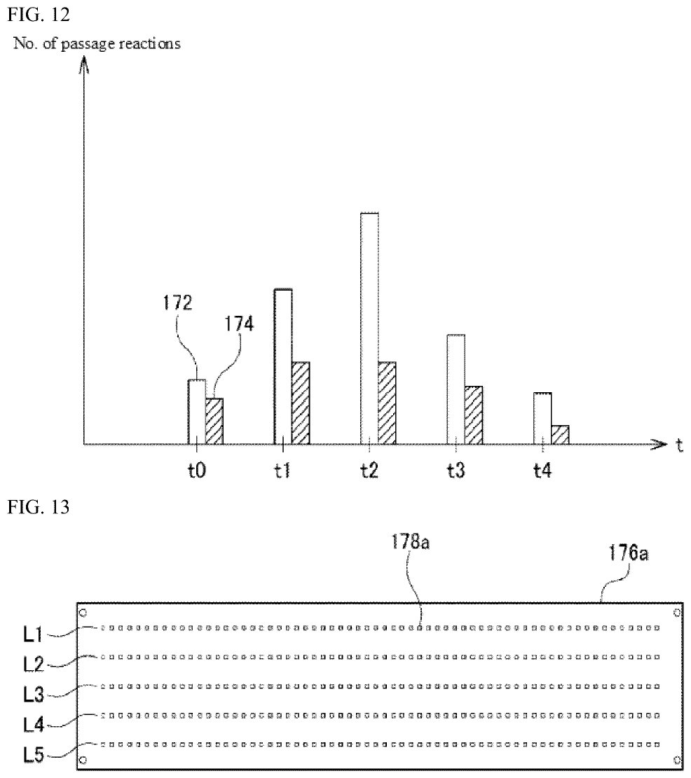

FIG. 12 is a graph showing the changes in time in the number of passage reactions in the case of a modified example.

In the case of a high-speed scanning method, when an article is dropped through the dropping slot 114, the light-emitting element 178b scans the object a plurality of numbers of times while it is falling. For this reason, the number of passage reactions also changes over time. FIG. 12 shows the changes in time in the number of responses when the prizes 172 and color balls 174 pass through the dropping slot 114. The horizontal axis indicates time, and the vertical axis indicates the number of passage reactions. Time t0 indicates the point at which the first passage reaction is detected due to an article falling, and time t4 indicates the point at which the last passage reaction is detected.

The acquisition determination unit 156 determines whether the article that has been dropped is a prize 172 or a color ball 174 (unwanted item) based on the pattern of changes in the number of passage reactions when the articles fall. For example, the acquisition determination unit 156 may determine whether the prize acquisition was successful based on whether the total number of passage reactions at each point from the time t0 when the first passage reaction occurred to the time t4 when the last passage reaction was detected is within the predetermined acquisition range. The same is also applies to the color balls 174. In addition, the acquisition determination unit 156 may determine whether a prize has been acquired based on the maximum or average number of passage reactions from time t0 to time t4.

The acquisition determination unit 156 may determine the type of article that has passed through the dropping slot 114 using artificial intelligence (AI). For example, it is possible to create a learning model in advance where the number of passage reactions at time t0 (K(0)), the number of passage reactions at time t1 (K(1)), etc. are set as input nodes, and the value that identifies prizes 172 or color balls 174 is set as the output node. During the operation phase, the acquisition determination unit 156 may determine whether the article that has passed is a prize 172 or a color ball 174 by setting the number of passage reactions for each time t0 to time t4 as the input node of the learning model.

FIG. 13 is a front side view of the prize sensor 176 in a modified example.

In the modification, the light-receiving elements 178a may be arranged in a plurality of rows L1 to L5 on the first detection plate 176a. The same applies to the second detection plate 176b. When an article passes through the dropping slot 114, a passage reaction is detected in each of the light-receiving elements 178a in rows L1 to L5. The acquisition determination unit 156 may determine whether the article that has fallen is a prize 172 or a color ball 174 (unwanted item) based on the number of passage responses in each row when the article falls.

The acquisition determination unit 156 may determine whether a prize has been acquired based on the number of passage responses detected by all light-receiving elements 178a when the article falls. Alternatively, the acquisition determination unit 156 may determine whether a prize has been acquired based on the number of passage reactions of the light-receiving element 178a in each row. For example, the acquisition determination unit 156 may determine that a prize has been acquired when the following conditions are met: the maximum number of passage reactions in the first row L1 is 5 or more, and the maximum number of passage reactions in the second row L2 is also 5 or more, and so on.

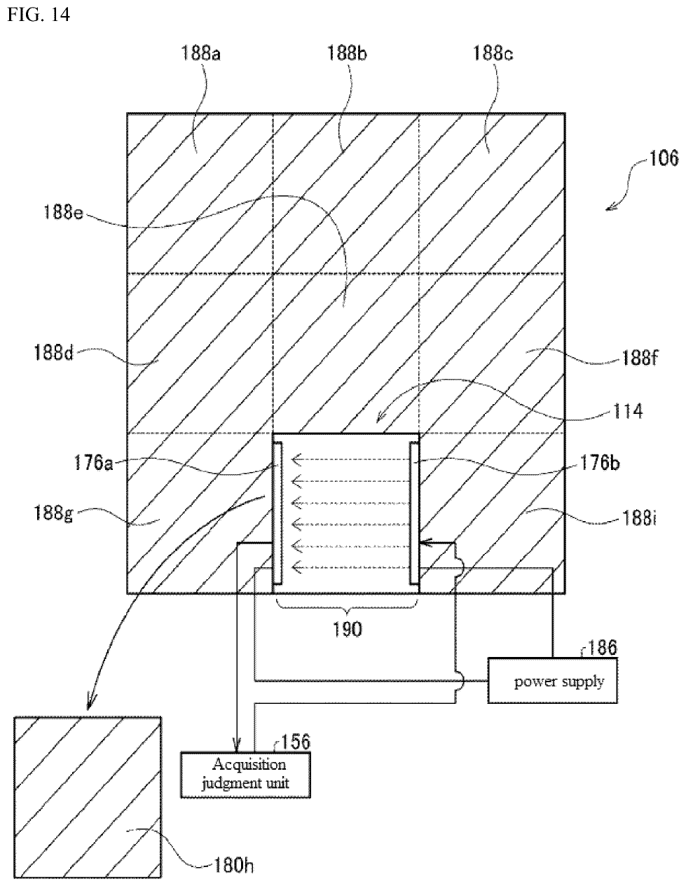

FIG. 14 is a first top view of the prize placement table 106, which is composed of a plurality of panels 188.

As a modified example, the prize placement table 106 may be constructed by fitting a plurality of panels 188 into it. The prize placement table 106 shown in FIG. 14 is configured so that nine panels 188 (panels 188a to 188i) can be inserted. Here, only panel 188h has been removed, so the dropping slot 114 is formed in the area corresponding to panel 188h. The operator can configure various dropping slots 114 by freely fitting the panel 188.

The operator places the sensor unit 190 at the dropping slot 114. The sensor unit 190 includes a first sensing plate 176a and a second sensing plate 176b. The sensor unit 190 is configured so that the light from the light-emitting elements 178b arranged on the second detection plate 176b is received by the light-receiving elements 178a arranged on the first detection plate 176a. The first detection plate 176a and the second detection plate 176b are connected to the power supply 186 of the crane game machine 100. In addition, the acquisition determination unit 156 controls the emission of light from the second detection plate 176b and detects the number of passage reactions on the first detection plate 176a.

In the same way as in one or more embodiments, the acquisition determination unit 156 identifies the article that passed through the dropping slot 114 based on the number of passage reactions in the sensor unit 190.

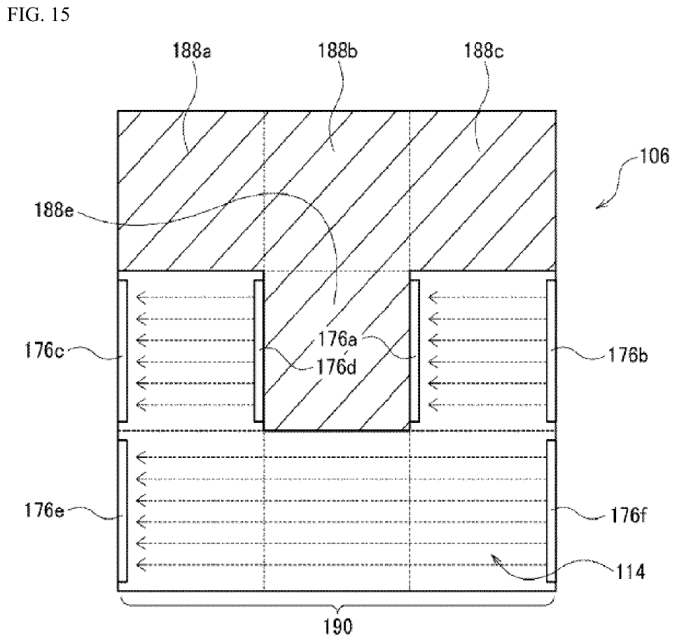

FIG. 15 is a second top view of the prize placement table 106, which is composed of a plurality of panels 188.

As shown in FIG. 15, the prize placement table 106 has five panels 188 removed from it to form a relatively large dropping slot 114. The operator inserts a sensor unit 190 that matches the shape of the dropping slot 114 instead of the five panels 188. In the sensor unit 190 shown in FIG. 15, the light from the second detection plate 176b is received by the first detection plate 176a and the light from the fourth detection plate 176d is received by the third detection plate 176c. In addition, the light from the sixth detector plate 176f is received by the fifth detector plate 176e.

The acquisition determination unit 156 identifies the article that passed through the dropping slot 114 based on the number of passage reactions in the first detection plate 176a, third detection plate 176c, and fifth detection plate 176e.

### Other Modifications

The acquisition range is set as the range of the number of passage reactions. The number of passing reactions corresponding to the acquisition range may be a single value, such as “5”, or it may be a plurality of values that include an upper and lower limit, such as “3 or more” or “5 or less”, or it may be a setting that does not include an upper or lower limit, such as “3 or more” or “5 or less”.

It is not necessary for the crane game machine 100 to display the settings screen 180. The store terminal may alternatively display the settings screen 180. The operator may set the prize range of the crane game machine 100 remotely by setting the prize range together with the ID of the crane game machine 100 on the settings screen 180 of the store terminal. The same applies to the unwanted range.

The inventory management unit 164 may count the number of unwanted articles such as the color balls 174 that have fallen. When the total number of unwanted articles that have fallen exceeds a predetermined threshold, the replenishment request unit 166 may send a removal instruction to the store terminal to remove the unwanted items that have accumulated in the prize storage part 104. With this type of control method, because the operator can remove the unwanted articles from the storage box at the time when a large amount of unwanted articles have accumulated in the storage box below the dropping slot 114, this reduces the workload of the operator.

The “light” in the prize sensor 176 may be visible light or invisible light. For example, the passage of an article may be detected using infrared rays, laser light, or the like. In addition, the prize sensor 176 may also detect the passage of an article using radio waves or ultrasonic waves.

In the settings screen 180, while only one type of prize size is set in one or more embodiments, a plurality of sizes can be alternatively set in the size settings area 184 to select a plurality of different prize sizes. For example, by setting the size of prize 172A and the size of prize 172B, it is possible to identify which of the two prizes passed through the dropping slot 114.

In the abovementioned example, although an explanation was provided concerning a method that assumes a crane game machine as an example of an article-winning game device, the prize detection method shown in one or more embodiments can also be implemented in an article-winning game device for acquiring prizes using a mechanism other than a crane. For example, we can imagine an article-winning game device in which the prize placement table 106 is divided into a plurality of levels and placed on the back of the prize storage part 104, rather than on a floor, whereon the prizes 172 are placed or hung. This type of article-winning game device is not equipped with a crane 108, but with a “article-winning unit” that grabs the prize 172 or the hanging area of the prize 172. The article-winning unit (acquisition mechanism) is driven by a movement control unit 154. The player moves the article-winning unit up, down, left and right using a control unit 118. The player moves the prize-winning unit up, down, left and right using the control unit 118 to determine the position, and then moves the prize-winning unit in the depth direction to make it grab the prize 172 or the hanging area of the prize 172, where after the prize 172 is dropped to win the prize. In this case, while almost the entire prize storage part 104 becomes the dropping slot 114 but since the prizes 172 are on the back side, the prize sensors 176 may alternatively be installed only on the far side of each side of the dropping slot 114. In the case of this type of article-winning game device, the number of sensors can be kept to a small number because the area where the passage of the prizes 172 is expected is limited, whereby the cost of the sensors can be kept low.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### Description of Reference Numerals

100 crane game machine, 102 base table, 104 prize storage part, 106 prize placement table, 108 crane, 110 door, 112 placement area, 114 dropping slot, 116 prize removal opening, 118 control unit, 120 settings display unit, 122 control stick, 124 grabbing button, 126 arm, 128 shielding plate, 130 crane driver, 132 design cover, 134 display bar, 140 user interface processing unit, 142 mechanism driving unit, 144 data processing unit, 146 data storage unit, 148 input unit, 150 output unit, 152 group of sensors, 154 movement control unit, 156 acquisition determination unit, 158 settings unit, 160 communication unit, 162 display unit, 164 inventory management unit, 166 replenishment request unit, 172 prize, 174 color ball, 176 prize sensor, 176a first detection plate, 176b second detection plate, 176c third detection plate, 176d fourth detection plate, 176e fifth detection plate, 176f sixth detection plate, 178 optical sensor, 178a light-receiving element, 178b light-emitting element, 178c light-receiving element, 178d light-emitting element, 180 settings screen, 182 sensor ON button, 184 size settings area, 186 power supply, 188 panel, 190 sensor unit

What is claimed is:

1. An article-winning game device comprising:
a game field that is disposed in a play space and includes:
a placement area where articles are placed; and
a dropping slot through which at least one of the articles may pass;
a crane that comprises an arm for acquiring at least one of the articles;
an operating panel that receives an operation by a player;
sensors that are arranged in the dropping slot and detect passage of the at least one of the articles; and
a data processor that:
drives the crane in response to the operation,
determines whether the at least one of the articles passing through the dropping slot is a first article to be acquired, and
sets, based on a user instruction, an acquisition range with respect to the first article, where
the acquisition range indicates a range of a number of passage reactions, and
the number of passage reactions indicates a number of sensors, among the sensors, that react to an article passing through the dropping slot, wherein
upon determining that the number of passage reactions with respect to the at least one of the articles passing through the dropping slot is within the acquisition range, the data processor determines that the at least one of the articles is the first article.

2. The article-winning game device according to claim 1, further comprising:
a user interface processor that causes the operating panel to display a settings screen, wherein
the data processor receives, on the settings screen, an input of a size of the first article, and sets the acquisition range depending on the size of the first article.

3. The article-winning game device according to claim 2, wherein:
the data processor further:
receives, on the settings screen, an input of a size of a second article that is not to be acquired, and sets an unwanted range that indicates a range of a number of passage reactions with respect to the second article depending on the size of the second article, and
upon determining that the number of passage reactions with respect to the at least one of the articles passing through the dropping slot is within the unwanted range, determines that the at least one of the articles is the second article.

4. The article-winning game device according to claim 1, wherein:
the first article and a second article that is not to be acquired are placed on the placement area of the game field, and
upon determining that the number of passage reactions with respect to the at least one of the articles passing through the dropping slot is outside the acquisition range, the data processor determines that the at least one of the articles is the second article.

5. The article-winning game device according to claim 1, wherein
the data processor sets, in a settings mode, the acquisition range based on the number of passage reactions with respect to the first article at a time when the user drops the first article into the dropping slot.

6. The article-winning game device according to claim 1, wherein:
the dropping slot has a rectangular shape having first to fourth sides,
first light-emitting elements are arranged on the first side of the dropping slot,
first light-receiving elements that detect light from the light-emitting elements are arranged on the third side opposing the first side in a position opposite to the first light-emitting elements;
second light-emitting elements are arranged on the second side of the dropping slot,
second light-receiving elements that detect light from the light-emitting elements are arranged on the fourth side opposing the second side in a position opposite to the second light-emitting elements, and
the data processor identifies, as the number of passage reactions with respect to the at least one of the articles passing through the dropping slot, a number of the first and second light-receiving elements on the third and fourth sides that are shielded from light by the at least one of the articles passing through the dropping slot.

7. The article-winning game device according to claim 1, wherein:
the sensors execute measurements a plurality of numbers of times whenever the at least one of the articles pass through the dropping slot, and
the data processor determines whether the at least one of the articles passing through the dropping slot is the first article based on the number of passage reactions with respect to the at least one of the articles passing through the dropping slot at each of the measurements.

8. The article-winning game device according to claim 1, wherein
the data processor further:
updates a remaining number of the first article on the game field in response to detection of the passage of the first article, and
requests replenishment of the first article in response to the remaining number falling below a predetermined threshold.

9. The article-winning game device according to claim 1, wherein:
the placement area of the game field comprises one or more panels,
the dropping slot is configured to be uncovered by the panels,
a first detector and a second detector are installed in the dropping slot, wherein light-emitting elements are arranged in the first detector, and
light-receiving elements are arranged to face the light-emitting elements, in the second detector; and
the data processor identifies, as the number of passage reactions, a number of light-receiving elements that are shielded from light by the at least one of the articles passing through the dropping slot.
